(19) United States
(12) Patent Application Publication
(10) Pub. No.: US 2018/0150910 A1
(43) Pub. Date: May 31, 2018

(54) SYSTEMS AND METHODS FOR PROCESSING BUSINESS DATA

(71) Applicant: PayPal, Inc., San Jose, CA (US)

(72) Inventors: Brian Christopher GRECH, San Francisco, CA (US); Ravi GUPTA, Newark, CA (US)

(73) Assignee: PayPal, Inc., San Jose, CA (US)

(21) Appl. No.: 15/809,080

(22) Filed: Nov. 10, 2017

Related U.S. Application Data
(60) Provisional application No. 62/428,057, filed on Nov. 30, 2016.

(51) Int. Cl. G06Q 40/02

(52) U.S. Cl. CPC G06Q 40/025

(57) ABSTRACT

A payment service provider obtains information indicative of a sales history of a merchant. The payment service provider determines, based on the information indicative of the sales history of the merchant, an interest rate for a loan to be offered to the merchant. The payment service provider receives a loan amount for the loan, and issues the loan, in the loan amount, to the merchant. The payment service provider collects repayments, from the merchant, for the (i) loan and (ii) interest accrued on the loan according to the interest rate determined for the loan.

### CROSS-REFERENCE TO RELATED APPLICATIONS

This application claims the benefit of U.S. Provisional Patent Application No. 62/428,057, entitled “Systems and Methods for Processing Business Data,” filed on Nov. 30, 2016, the disclosure of which is hereby expressly incorporated herein by reference in its entirety.

### FIELD

The present disclosure rerates generally to systems and methods for processing business data, and more particularly, to implementing working capital for merchants.

### BACKGROUND

Merchants typically need capital or funding at various times to build, expand, sustain, or save their business. Current lending/capital advance products tailored to SMBs (small and medium businesses) may not be desirable to a very large market of SMBs. The five largest U.S. banks hold approximately 40% of all domestic deposits, yet make only 16% of all business loans with balances of $1 million or less. This shows the large need for financial management and funding to support SMBs in the US.

Typically, business owners are drawn into bank branches by a deposit relationship or credit marketing, only to be met with a bureaucratic and slow loan process that consumes time and requires significant business and personal financial documentation and approval from layers of decision-makers. Some merchants may not have the necessary credit or history to receive a loan from a bank. Further, the bank may offer small or medium sized merchants with loan terms that have excessive interest rates or fees. The process also results in high rejection rates. As a result, 73% of small business owners who need a loan don't bother to apply for one, often because they believe their business lacks the financial history necessary for bank loan approval. One primary alternative to bank business loans for entrepreneurs in recent years has been the home equity loan. But when home values fall, many banks pull back on home equity lending. As a result, many small business owners turn to consumer credit products or private money for funding (when available) or simply give up on securing the capital they need to grow.

Since the expansion of the Internet, banking has developed methods to interact directly with individuals and SMBs through computer interfaces. The backend of these communications and interactions incorporates computer-analysis techniques available due to the data available and data analysis techniques possible only through the use of computerized analysis.

Even in times of expansion, banks' lending processes may not be friendly to small or new businesses, because it is not economical to devote a trained credit professional to evaluating loan applications for amounts less than $50,000. Further, computer-analysis for SMBs is complex and complicated, so banks are typically either unwilling or unable to build expert systems for analysis of the requests and considerations of SMBs. Therefore, there is a need for systems and methods that implement easy, convenient, flexible merchant cash advance products with transparent terms for merchants.

### BRIEF DESCRIPTION OF THE DRAWINGS

FIG. 1 is a block diagram of a networked system suitable for implementing merchant working capital according to some embodiments of the present invention.

FIG. 2 is a flowchart illustrating a method for loan application, some embodiments of the present invention.

FIG. 3 is a flowchart illustrating a method for loan repayment, according to some embodiments of the present invention.

FIG. 4 is a block diagram of a computer system suitable for implementing one or more components in FIG. 1, according to some embodiments of the present invention.

FIG. 5 is a flowchart illustrating a method for issuing a loan, according to some embodiments of the present invention.

FIG. 6 is a flowchart illustrating a method for loan repayment, according to some embodiments of the present invention.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

According to some embodiments, a method of providing working capital to a merchant is executed by one or more hardware processors programmed to perform the method, includes obtaining, at one or more hardware processors of a payment service provider, information indicative of a sales history of the merchant. The method also includes determining, at the one or more hardware processors of the payment service provider based on the information indicative of the sales history of the merchant, an interest rate for a loan to be offered to the merchant. The method additionally includes receiving, at the one or more hardware processors of the payment service provider, a loan amount for the loan. The method further includes issuing, by the one or more hardware processors of the payment service provider, the loan, in the loan amount, to the merchant. The method further still includes collecting, from the merchant, repayments for the (i) loan and (ii) interest accrued on the loan according to the interest rate determined for the loan. These methods and techniques incorporate computer-analysis incorporating computer-to-computer information ported from a merchant's computer system to a management computer system.

According to other embodiments, a tangible, non-transitory computer readable medium, or media, storing machine readable instructions that, when executed by one or more processors of a payment service provider, cause the one or more processors to obtain information indicative of a sales history of a merchant, determine, based on the information indicative of the sales history of the merchant, an interest rate for a loan to be offered to the merchant, receive a loan amount for the loan, issue the loan, in the loan amount, to the merchant, and collect, from the merchant, repayments for the (i) loan and (ii) interest accrued on the loan according to the interest rate determined for the loan.

In one embodiment, a system or method for providing capital to merchants is provided. As described herein, systems and methods enable a financial service provider to implement working capital for merchants, wherein the working capital is directly related to the sales and/or cash flow of the merchant or business. In particular, a payment service provider may provide working capital to merchants based on the merchant's sales or payment history. For example, based on a merchant's sales or payment history, a close-ended (fixed amount) loan based on expected customer sales, with no fixed duration, no end date, and no interest, is provided to the merchant. The sales data is compiled electronically from the merchant's computer system to the financial service provider's system, wherein the data may be stored in a local database and is available for data analysis.

As another example, an interest rate for the loan may be determined based on a merchant's sales or payment history, and interest on the loan may be accrued according to the determined interest rate until the loan is repaid by the merchant. The “loan” may be viewed as a hybrid cash advance/loan product. Further, the repayment for the loan may be derived from future sales. The payment service provider may monitor sales volume of the merchant based on payment activities processed through the payment service provider. Based on the loan term, a portion of the sales revenue of the merchant may be directed for repayment of the loan. Thus, the repayment may be contingent on sales volume to provide the merchant with flexibility in loan repayment.

In one embodiment, the payment service provider may offer loan terms based on a merchant's sales, payments, and/or cash flow. For example, the amount of loan offered to a merchant may be a percentage of a merchant's annual sales revenue processed through the payment service provider. In one embodiment, a merchant may select an amount to borrow up to a maximum amount and may select a percentage of future sales processed through the payment service provider service as repayment for the loan. Further, a single fixed fee may be assessed based on the amount, repayment percentage, past business sales volumes, and risk score, in an embodiment. Thus, the fee amount is known by the customer before loan amount is funded. Additional fees, such as origination, utilization, pre-payment late fees, may not be imposed to simplify the loan terms.

In another embodiment, an interest rate may be determined for the loan. For example, an interest rate, such as an annual percentage rate (APR), may be determined based on merchant's sales, payments, cash flow and/or other factors that may indicate a risk level for collecting repayment of the loan from the merchant. In this embodiment, the loan may accrue interest according to the determined interest rate until the loan is repaid by the customer.

The payment service provider may periodically determine the sales revenue of the merchant and transfer the designated percentage of the sales revenue to repayment until the loan amount plus the fee amount are paid in full. Additionally or alternatively, a merchant may make ad hoc payments with no penalty. In one embodiment, the payment service provider may offer the merchant with a second loan when the first loan is paid in full.

In some embodiments, other operational criteria are used to determine the parameters of the funding for a business, such as a non-profit or not-for-profit. For example, a non-profit may achieve gains in social impact, such as microfinancing of successful ventures. This information may provide sufficient information to the financial service provider to support a variety of funding scenarios. As the business and the financial service provider interface with each other electronically, the data is continually adjusted, stored, monitored, analyzed and updated. This enables real-time analysis and results to provide fast response and support to the business.

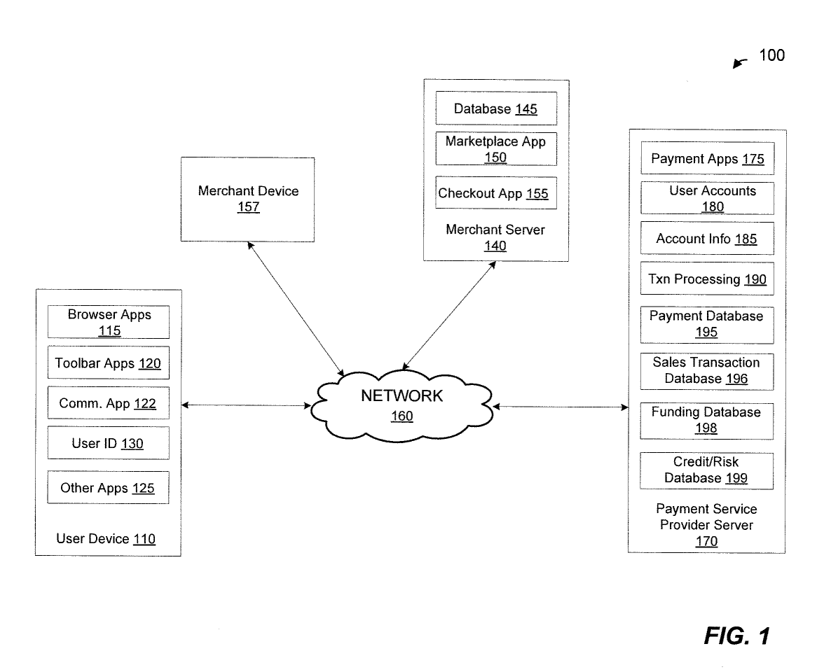

FIG. 1 is a block diagram of a networked system 100 suitable for implementing working capital for merchants according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 includes a payment service provider server 170 that is adapted to communicate with merchants, such as through merchant server 140. Payment service provider server 170 is in communication with merchant server 140 over a network 160. Payment service provider server 170 may be maintained by a payment service provider, such as PayPal, Inc. of San Jose, Calif., or other financial service provider. The merchant provides sales data, or other operational or cash flow data, electronically through the network 160 to payment service provider server 170. The payment service controls the payment service provider server 170 and has configured the various modules and components within the server 170 to receive the data and process according to computer-analysis techniques. Specifically, the server 170 includes capabilities to receive electronic data in a variety of forms, to extract the significant data for use in computer-analysis, to store the received data, and to apply specific and/or general criteria for computer-analysis. The computer-analysis may also incorporate anonymized data related to other business for comparison. In some embodiments, the computer-analysis may include machine learning techniques, such as neural networks or expert systems. Some computer-analysis techniques incorporate iterative computing to converge on a solution that meets a set of criteria.

A user, such as a sender or consumer, may utilize a user device 110 to perform a transaction using payment service provider server 170. User may utilize the user device 110 to initiate a payment transaction, receive a transaction approval request, or reply to the request. Note that transaction, as used herein, refers to any suitable action performed using the user device, including payments, transfer of information, display of information, and so forth. For example, a user may utilize the user device 110 to initiate a deposit into a savings account or other financial transaction. Although only one user device is shown, a plurality of user devices may utilize the payment service provider to make purchase at the merchant.

User device 110, merchant server 140, and payment service provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. In some embodiments, the merchant server 140 and the payment service provider server 170 include funding specific elements incorporated into the various components, such as for example, where the server 170 instructs the merchant server 140 to store specific information, or to install a module for communication with server 170. The installed module may track information at the merchant server 140, and send at least a portion of that information to the server 170. In some embodiments, the tracked information may be converted to a different format or compiled into an indicator, which is then sent to the server 170. For example, the module may track all sales within a given time window and provide an average, mean, standard deviation and so forth to the server 170.

Network 160 may be implemented as a single network or a combination of multiple networks. For example, in various embodiments, network 160 may include the Internet or one or more intranets, landline networks, wireless networks, and/or other appropriate types of networks. In some embodiments, the network 160 includes a cloud service (not shown) that may be used by one or both of the merchant server 140 and the server 170 to store and/or analyze information.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

The user device 110 is illustrated in system 100 to show the interaction of a user via network 160 with the merchant and the payment service provider. The present invention applies to alternate interactions and transaction scenario, such as where the user purchases an item at the merchant location through a Point of Sale (POS) device. In such cases, the user may access the payment service provider through the POS device at the merchant.

Applications 125 may also include email, texting, voice and IM applications that allow user to send and receive emails, calls, and texts through network 160, as well as applications that enable the user to communicate, transfer information, make payments, and otherwise utilize a smart wallet through the payment service provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user with a particular account maintained by the payment service provider. A communications application 122, with associated interfaces, enables user device 110 to communicate within system 100.

Merchant server 140 may be maintained, for example, by a merchant or seller offering various products and/or services. The merchant may have a physicalPOS at their store location. The merchant may have a merchant account with the payment service provider. Merchant server 140 may be used for POS or online purchases and transactions. Generally, a merchant server may be maintained by an entity that receives financial transactions, including charities as well as banks and retailers. For example, a payment may be a donation to charity. Merchant server 140 may include a database 145 identifying available products (including digital goods) and/or services (e.g., collectively referred to as items) which may be made available for viewing and purchase by user. Accordingly, merchant server 140 also may include a marketplace application 150 which may be configured to serve information over network 160 to browser 115 of user device 110. In one embodiment, user may interact with marketplace application 150 through browser applications over network 160 in order to view various products, food items, or services identified in database 145.

Merchant server 140 also may include a checkout application 155 which may be configured to facilitate the purchase by user of goods or services online or at a physical POS or store front. Checkout application 155 may be configured to accept payment information from or on behalf of user through payment service provider server 170 over network 160. For example, checkout application 155 may receive and process a payment confirmation from payment service provider server 170, as well as transmit transaction information to the payment service provider and receive information from the payment service provider (e.g., a transaction ID). Checkout application 155 may be configured to receive payment via a plurality of payment methods including cash, credit cards, debit cards, checks, money orders, or the like.

A merchant may also use a merchant device 157 to communicate with the merchant server 140 and/Or the payment service provider server 170 via the network 160. The merchant device 157 may be a mobile device, such as a cellular phone, a smart phone, a tablet, a dedicated merchant device, etc. Alternatively, the merchant device 157 may be a wired communication device such as a personal computer. The merchant device 157 may be configured to accept and process payment transactions, such as payment transactions initiated by a user via the user device 110. The merchant device 157 may also communicate with the merchant server 140, for example to electronically obtain from the merchant server 140 information related to merchant's inventory maintained by the server 140, information related to sales transactions, including, for example, time of the sales transactions, processed by the merchant server 140, customer information maintained by the server 140, and so forth. The merchant device 157 may transmit such information to the payment service provider server 170 for use by the payment service provider server 170 in computer-analysis that the service provider 170 performs in relation to the merchant, such as computer-implemented techniques for assessing or reassessing a risk level of providing a loan or funding to the merchant, determining loan terms for the merchant, and so forth.

Payment service provider server 170 may be maintained, for example, by an online payment service provider which may provide payment between user and the operator of merchant server 140. In this regard, payment service provider server 170 includes one or more payment applications 175 which may be configured to interact with user device 110 and/or merchant server 140 over network 160 to facilitate the purchase of goods or services, communicate/display information, and send payments by user of user device 110.

Payment service provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user. Advantageously, payment application 175 may be configured to interact with merchant server 140 on behalf of user during a transaction with checkout application 155 to track and manage purchases made by users and which and when funding sources are used.

A transaction processing application 190, which may be part of payment application 175 or separate, may be configured to receive information from user device 110 and/or merchant server 140 for processing and storage in a payment database 195. Transaction processing application 190 may include one or more applications to process information from user for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user, as well as create new accounts if necessary.

In some embodiments, payment service provider server 170 maintains a sales transaction database 196 storing sales transaction history of various merchants. The sales transaction history may include sales revenue, sales volume, types of sales, time, and location of various sales transactions processed through payment service provider server 170. Payment service provider server 170 may analyze the sales transaction history to determine and offer loan terms to a merchant.

In some embodiments, payment service provider server 170 also maintains a funding database 198 storing loan accounts of various merchants or customers who had taken a loan or other funding option from the payment service provider. The loan accounts may include loan information such as, a loan amount, repayment terms, projected payoff date, current loan balance, and the like. Thus, payment service provider server 170 may monitor and keep track of various loan accounts and their repayment progress.

Payment service provider server 170 may maintain a credit/risk or risk database 199 storing credit and/or risk information of various merchants or customers. The credit/risk information may include sales or purchase history, payment history, transaction volume, credit scores, types of funding sources, and the like. The credit/risk information may be used to determine loan terms for the merchants or customers. A variety of information and data may be used for computer-analysis of risk.

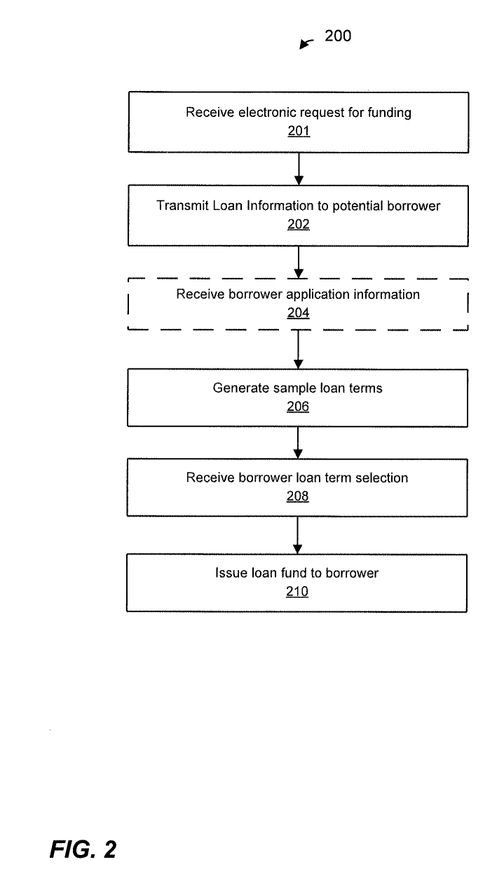

FIG. 2 is a flowchart illustrating a process 200 for loan or funding application, according to an embodiment. Process 200 may be executed by payment service provider server 170 to determine loan and/or funding terms for a merchant, such as to issue a loan to the merchant. Process 200 may be executed by a computer or a server of a payment service provider. In an embodiment, process 200 may be executed by the payment service provider server 170 of FIG. 1. For example, process 200 may be executed by one or more hardware processors of the payment service provider server 170.

At step 201, server 170 receives an electronic request via network 160 for funding from merchant server 140. The request may indicate a desired amount, or may request information as to options for the merchant. This information is received at server 170 and is applied to a computer-analysis for generation of a result. The result considers information from the merchant as to sales history available to the server 170. For example, in some embodiments the financial service provider is able to access financial transactions, such as sales, of the merchant through the merchant server 140 or from the database and records stored by the financial service provider at the server 170 or at other hardware and/or server(s) (not shown) of the financial service provider. This information may include information of sales that are transacted through the financial service provider. In some embodiments, this information may include all sales records of the merchant, or may include sales records of the financial service provider and their partners. A variety of methods may be used to extract and store the sales and transaction information of the merchant. The goal of these methods is to compile the most comprehensive information available to provide an accurate computer-analysis of the risk and/or opportunity of funding the merchant.

As used in the following examples, loan information is used for clarity, but other funding information may also be used to determine a variety of funding options. At step 202, payment service provider server 170 transmits loan information to merchant device 140. The loan information is received and may be presented to a merchant in a variety of ways, such as a display terminal, an email, a website notification, terminal mobile alert, such as text message, or a telephone call. In some embodiments, the loan is provided directly to the merchant server 140 according to prearranged agreement.

Payment service provider server 170 may send an email including the loan information or a link to a website presenting the loan information. In another example, display terminals installed at the merchant, or at public places, may be used to present the loan information to potential customers or merchants via the Internet. This information may be presented in response to a merchant request for a possible loan, which can be from a web page or an app of a payment service provider associated with an account of the merchant with the payment service provider or on a non-user specific web page or mobile screen. The loan information may provide an introduction to potential customers or merchants and may entice them to apply for a loan from the payment service provider. For example, an electronic information tour may be provided by the payment service provider to a merchant via the Internet, such as via a website.

As an alternate step 204, payment service provider server 170 may receive loan application information from a customer or a merchant, e.g., the borrower. Loan application information may include a specific loan amount or type, a modification request for a loan option, and so forth. For example, a merchant may use merchant server 140 to apply for a loan from the payment service provider 201. In some embodiments, the merchant may communicate with server 170 through a variety of other communication devices. Payment service provider server 170 may begin the loan application process by requesting information from the customer or merchant. For example, an information form with fill-in areas may be presented to the customer or merchant at user device 110 or merchant server 140 to receive information from the customer or merchant. Certain information may be prefilled based on existing knowledge of the merchant, such as based on information associated with the merchant's account with the payment service provider. Prefilled information may be changed by the merchant if not correct. In some embodiments, the application information may be to apply for a new or different loan or funding option. In some embodiments, the application information may be in response to a request from the payment service provider, or may be additional information that may be pertinent to determination of the loan options, such as seasonality of sales, or an unanticipated increase or decrease in sales due to an unforeseen event. This may be such as a disruption in supplier, or a natural event that increases sales of staple products, and so forth.

At step 206, payment service provider server 170 generates sample loan terms to be selected by the customer or merchant. This may be a general selection of options available to the merchant or may be a specific option(s) created for this particular merchant. The loan terms may be generated based on the customer or merchant's sales history, payment history, cash flow history, and/or other transactions processed by the payment service provider. For example, a qualified maximum loan amount may be determined based on a merchant's annual sales revenue. The specific computer-analysis done may incorporate these or other criteria. For example, in some embodiments, the specific analysis technique may incorporate information learned from analysis of sets of data including multiple merchants or businesses. In this way, machine-learning may identify trends or significant measures that are pertinent to such analysis. In one embodiment, the computer-analysis inputs include a computer security measure, a number of hacks to a merchant system, the brand strength of the business, the competitive landscape, the return on assets, supplier-dependency, and so forth. A variety of measures may be determined by considering multiple merchants, some of which may appear to unrelated to the business or conventional loan underwriting methods.

Payment service provider server 170 may look up the annual sales revenue of a merchant for the past three years and may average them to determine an average annual sales revenue. Payment service provider server 170 may use a percentage, e.g., 8%, of the average annual sales revenue as the maximum loan amount allowed to be borrowed by the merchant. The qualified maximum loan amount also may be adjusted based on consistency of annual sales revenue, length of merchant history, type of merchant business, credit rating, customer rating, and the like. For example, the qualified maximum loan amount may be increased if the merchant has a long history of consistent annual sales revenue or has good credit and/or customer ratings. Thus, loan terms may vary between merchants, depending on various factors, such as those discussed above.

According to at least some embodiments of the present invention sales data from a merchant is available to the payment service provider at least for those sales processed through the payment service provider. The sales information is stored and tracked to calculate a repayment scheme.

At step 208, payment service provider server 170 may receive the user or merchant's selections of various loan terms. For example, the user or merchant may enter a loan amount of $10,000 and select a periodic repayment option, such as 15% of daily sales, and in some situations a one-time loan fee of $744 for a total amount of $10,744, which is to be paid off by 15% percent of future sales revenue periodically. A summary of the selected loan terms may be presented to the borrower for confirmation. In this way, the repayment amount is based on direct application to the daily sales, or other period sales.

Once the borrower confirms the loan terms, payment service provider server 170 may generate a loan contract based on the selected loan terms. In the contract, the borrower agrees to allow the payment service provider to automatically deduct a percentage of the borrower's future sales revenue for repayment to the loan until the loan is paid off. Other terms and conditions of the loan also may be included in the contract, such as that the borrower will continue to use the payment service provider for future sales transactions and will not divert the sales transactions away from the payment service provider. The borrower is requested to confirm and accept the terms of the loan.

At step 210, the payment service provider may issue the loan funds to the borrower. For example, the loan funds may be deposited directly into the borrower's payment or merchant account. The loan approval process may take only a few minutes, because the payment service provider already has the credentials of the borrower required for loan approval and may make a determination for approval in a fast manner. After the loan funds have been issued, payment service provider server 170 may send a message, via email or text messaging, to the borrower informing the borrower that the loan funds have been deposited to the borrower's account. Thus, the borrower may use the loan funds for his or her business. The repayment may begin after the loan funds are deposited. In some embodiments, the loan funds are made available as needed to the merchant, wherein the total loan amount is first allocated to a merchant account at the payment service provider and the merchant server 140 may withdraw money as needed. This may result in more friendly loan terms for the merchant.

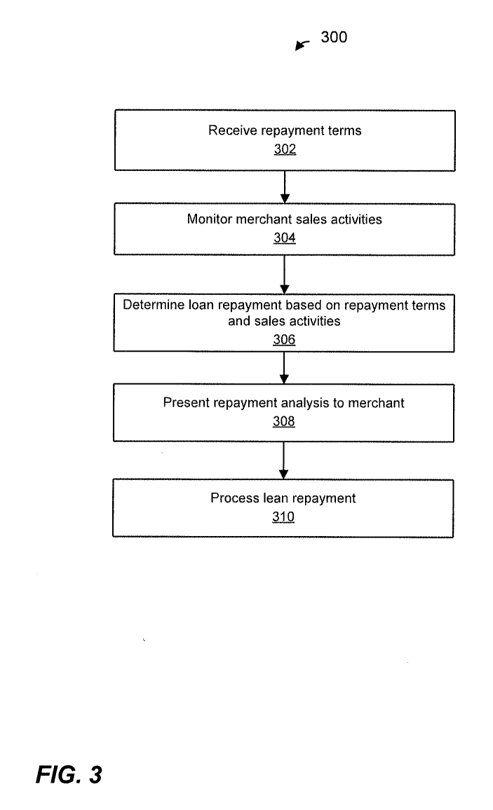

FIG. 3 is a flowchart illustrating a process 300 for automated loan repayments, according to an embodiment. Process 300 may be executed by a payment service provider server to collect repayment of a loan issued to a merchant. Process 300 may be executed by a computer or a server of a payment service provider. In an embodiment, process 300 may be executed by the payment service provider server 170 of FIG. 1. For example, process 300 may be executed by one or more hardware processors of the payment service provider server 170.

After the loan application is approved and the loan funds are issued to the borrower, the loan repayment process may begin. At step 302, payment service provider server 170 may receive or retrieve repayment terms as agreed to during the loan application process. The repayment terms may indicate the frequency of payment, percentage of sales revenue to be deducted as payment, and the total loan amount including the one-time loan fee. The repayment frequency may be every day, every two days, every week, every two weeks, every month, or any other time period agreed to by the borrower and payment service provider.

At step 304, payment service provider server 170 may monitor the borrower's transactions for sales activities. Sales activities may include all transactions except for fund transfers from a linked account of the borrower's account, personal payments, chargebacks, or the like that are not transactions related to a customer's purchase at the merchant borrower. The sales transaction amount may include taxes and shipping. The server 170 may monitor the merchant's activities via communication with the merchant server 140 real-time, wherein the percentage repayment is made on each transaction, or on a small time window, such as every 5 minutes. Some merchants may prefer the real-time repayment rather than a daily or weekly repayment arrangement.

At step 306, payment service provider server 170 may determine loan repayment amount for each repayment period based on the sales transactions. In particular, payment service provider server 170 may aggregate the sales transactions during a repayment period to determine total sales revenue for that repayment period. Based on the loan terms, payment service provider server 170 may determine a percentage of the total sales revenue as the repayment amount for that repayment period. For example, if the borrower has sales revenue of $1,000 on Monday and the loan terms indicate that 15% of the daily sales revenue is to be deducted for loan repayment, the payment service provider may determine that $150 of Monday's sales revenue is to be used for loan repayment. Payment service provider server 170 may deduct $150 from the borrower's payment or merchant account on Tuesday. Payment service provider server 170 may implement the repayment automatically. Thus, there is no need for the borrower to spend time and effort in determining the correct repayment amount and making the repayment. For real-time repayment, the sum of the real-time repayment amounts at the end of the day is equal to the daily repayment amount, but provides refined visibility and financial management to the merchant.

If the borrower has spent the sales revenue such that there is not sufficient funds in the merchant's account to be deducted for repayment, payment service provider server 170 may record the repayment amount for this repayment and deduct the repayment amount in the next repayment period or whenever sufficient fund becomes available in the merchant's account. For example, if the repayment amount is $150, but the merchant has only $50 left in the account, payment service provider may deduct $50 first and then deduct $100 as a catch-up repayment whenever $100 becomes available in the merchant's account. No late fee is imposed on the borrower. Nevertheless, when severe or persistent repayment avoidance is observed by the payment service provider, the loan may be canceled and the remaining balance of the loan may become due immediately.

Other conditions that may be considered defaults on the loan include: borrower stops using the payment service provider as a form of payment, borrower deliberately directs sales volume away from the payment service provider, and/or frequently transferring sales proceeds out of the merchant account before the automated repayment occurs. Payment service provider server 170 may continuously monitor for these conditions. When one or more of these conditions are observed, payment service provider may notify the borrower and may begin the process of recalling the loan. Therefore, although there is no penalty for the merchant when sales activities have slowed, the merchant may not take deliberate action to avoid repayment, which is tied to sales that have occurred.

At step 308, the payment service provider may present a summary of loan repayment progress to the borrower. The summary may be presented to the borrower periodically or by the borrower's request. For example, an email or paper mail including the summary may be sent from the payment service provider to the borrower. The borrower also may log into an online loan account at payment service provider's website to review the summary.

At step 310, the payment service provider may process the loan repayment. For example, the payment service provider may deduct the repayment amount from the borrower's merchant account and credit the repayment to the payment service provider. In some embodiments, the system may allow the borrower to make additional repayments without penalty.

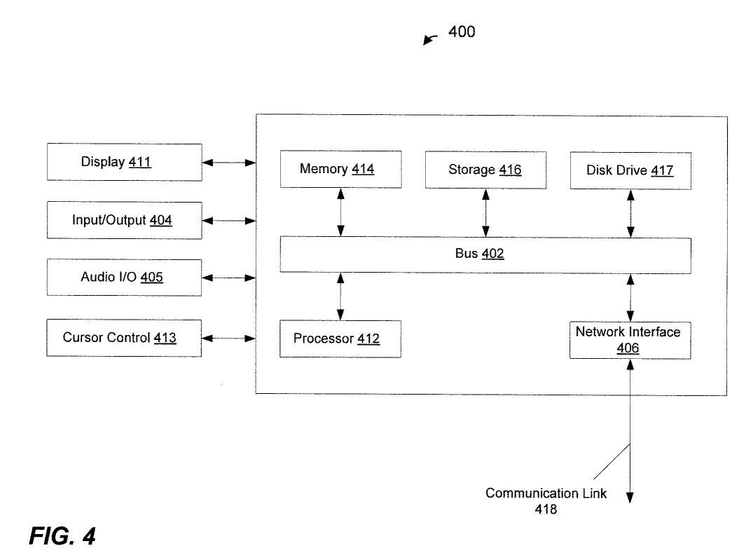

FIG. 4 is a block diagram of a computer system 400 suitable for implementing one or more embodiments of the present disclosure. It should be appreciated that each of the devices utilized by users, merchants, and payment service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment service provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices. Processor 412 may execute one or more processes associated with determining loan terms for a merchant and for repayment of the loan as described above. It should be appreciated that although only one processor 412 is shown, the computer system 400 may include multiple processors 412, and several processors 412 may be used to execute one or more processes associated with determining loan terms for a merchant and for repayment of the loan as described above.

Components of computer system 400 also include a system memory component 414 (e.g., RAM), a static storage component 416 (e.g., ROM), and/or a disk drive 417. Although only one memory component 414, only one static storage components 416 and only one disk drive 417 are shown, the system 400 may include multiple memory components 414, multiple static storage components 416 and/or multiple disk drives 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

In some embodiments, the server 170 transmits information for display to a potential merchant to introduce loan products, describe benefits of the loan products, such as fast and easy application process, sales revenue based repayment terms, fast funding, low and fixed fee, and no credit check, and an interaction method, such as a button or a link by which a potential customer or merchant may initiate funding, receive information, or tour the loan products offered by the payment service provider through server 170.

The server 170 transmits information on the basic loan terms, such as the loan amounts corresponding to sales volume. Additionally, there are options such as fixed fee, no interest, as well as possible penalties. In these scenarios, the repayment may be based on sales volume, may be fixed repayment, or may be a combination thereof. Further, a new loan may be applied when a previous loan is paid in full or paid to a specific level. The transmitted information may be displayed as graphical illustrations showing a fixed percentage of daily sales revenue used for repayment, or other repayment method. On days that have no sales revenue, no repayment may be made.

The server 170 transmits information may describe the price or cost of the loan and examples. In one sample repayment and pricing options, the transmitted information includes a table illustrating different repayment and pricing options. The information may be presented to a merchant, who may then select a percentage of daily sales revenue as the repayment. The information may be presented in a format of % to payment service provider/% to merchant, such as 15%/85%. A one-time fixed fee may be determined based on the loan amount, the daily repayment percentage and sales history. For example, a lower daily repayment percentage may correspond to a higher fee. The customer or merchant may choose a loan amount up to a maximum amount. In addition, a total amount to be repaid is listed at a last column to illustrate the total cost of the loan product.

The server 170 transmits information that provides real-time or periodic updates on the repayment terms and processes. In particular, as the repayments are automatically processed by the payment service provider, the repayment status are updated periodically or in real-time. The transmitted information may include loan balance, loan terms, various conditions for the borrower are to follow, payments processed through sales transactions through the payment service provider and not directing sales payment volume away from payment service provider. Other terms indicate that the repayment percentage does not include transaction fees. The automated repayment may occur a day after the related sales occur. If the proceeds of sales are spent, payment service provider may deduct catch-up payments. Further, no fees or penalties are imposed for catch-up payments. A graphical calendar may also be presented to illustrate that a percentage of the sales revenue from yesterday may be used as repayment for today, according to an example embodiment, wherein if no sales occurred today, no repayment is made tomorrow.

The server 170 may also transmit information as to a comparison table comparing the payment service provider's loan product with other loan products. The comparison table may include application time, funding time, approval rate, repayment terms, fees, interests, credit check, personal guarantee, and pre-payment penalty. The comparison table may illustrate that the payment service provider's loan product has easy and fast application process, quick funding, high approval rate, single fixed fee, no interest, no credit check requirement, no personal guarantee requirement, and no pre-payment penalty. Thus, the payment service provider's loan product does not affect a loan borrower's personal or business credit score. Further, a button or a link may be provided to merchant server 140 that allows a customer or a merchant to begin a loan application process.

When a customer or a merchant initiates the loan application process, information is transmitted to the server 170. The loan application process may include steps such as: confirm your information, choose your terms, and get your funds. The application process may be completed in real-time, and the loan funds may be transferred to the customer or the merchant's payment account immediately after the application is approved.

The information transmitted from merchant server 140 to server 170 includes business information that may include business name, federal Tax ID, business type, address, year of establishment, industry type, purpose of loan and so forth. The information also may include the primary business contact information, such as information of the business owner. The primary business contact information may include an email address of the business owner, name of the business owner, birth date, social security number, address, and the like.

Where the merchant already has a merchant account with the payment service provider, the payment service provider will already have much of the merchant's information and the merchant may simply log into the merchant's account at process step 204 of FIG. 2.

The server 170 receives the information required for computer-analysis to determine the loan specifics; the server 170 may need to request further information form merchant server 140. The computer-analysis provides loan parameters, such as approval status, a qualified maximum loan amount, repayment method and so forth. The server 170 also may indicate if there is potential for additional loans based on repayment of prior loans.

A payment service provider server 170 transmits the maximum loan amount to the merchant server 140. The customer or the merchant may enter a desired loan amount up to the maximum loan amount.

Payment service provider server 170 also may generate different options for repayment. Each repayment option may indicate a percentage of sales revenue designated for repayment, a one-time loan fee, a loan amount, and a total repayment. Each repayment option may have a different one-time loan fee. Payment service provider server 170 may determine the one-time loan fee based on the percentage of sale revenue for repayment, the credit/risk score of the borrower, the loan amount, and the like. For example, a smaller percentage of sales revenue for repayment may correspond to a higher one-time loan fee. Further, borrowers with higher risk or lower credit rating may correspond to a higher one-time loan fee. Merchants with a longer and consistent sales revenue history may be given a lower one-time loan fee.

If the borrower is not qualified for any types of loans based on the borrower's credentials, payment service provider server 170 may inform that no loans are available due to a specific reason, such as lack of transaction history, lack of extensive sales history, or the like. Thus, the borrower may have a reason and continue to build the borrower's credential to be qualified for loans in the future.

In some embodiments, a variety of different repayment options are determined and transmitted to the merchant server 140. For example, the first option has a 10%/90% arrangement, in which 10% of the borrower's sales revenue would be used for repayment to the loan, while the merchant maintains 90% of sales. As the percentage for repayment increases in the second, third, fourth, and fifth options, the one-time loan fee may decrease. A graphical representation of the repayment percentage may be presented to the borrower to help borrower visualize the sales revenue v. repayment ratio. In some embodiments, based on the borrower's past sale revenue, a projection of repayment schedule may be presented to the borrower to predict how long and when the loan is expected to be paid off. Any number of options may be presented, again depending on merchant information. In other embodiments, the same number and/or options are presented to all potential borrowers or to certain groups of potential borrowers sharing one or more common traits or characteristics. In another embodiment, the potential borrower may set its own terms, which the payment service provider may accept, decline, or revise.

There are a variety of methods to visualize a loan repayment and its progress. The summary may include the original loan amount, the one-time loan fee, the initial loan balance, payments made to date, pending payments, catch-up payments, and the outstanding balance. Graphical charts, such as line, bar, or pie charts, may be used to provide a visual representation of the repayment progress. A pie chart may be used to depict the outstanding balance v. amount paid. Other charts, such as bar chart or a line graph, may be used to depict repayment over time. The repayment trend also may be used to predict a payoff date when the entire loan balance is expected to be paid in full.

In some embodiments, a user interface may be provided at payment service provider's online website or mobile app to receive additional repayments from borrowers. The user interface may allow a borrower to enter the additional amount to be paid and the funding source of the additional repayment. For example, the additional payment may be deducted from the borrower's payment account or other funding sources. Unless the additional payment pays off the loan balance, the additional payment may not affect the automated repayment process that occurs every repayment period. Thus, the automated repayment process may continue to be implemented.

The following is an exemplary scenario in which the above processes 200 and 300 may be implemented.

Merchant A owns and operates a small flower shop in a small town. Merchant A's flower shop accepts payment service provider A as one of the methods of payment. Business has been good and merchant A has been contemplating the possibility of expanding her store. The estimated cost for the store expansion project is $15,000. Merchant A has been talking to several banks about getting a loan for the store expansion project, but has not been getting good receptions from the banks.

The payment service provider A offers options for business loans to qualified merchants of the payment service provider A. Merchant A has been a merchant of the payment service provider A for several years. This means that transactions processed through payment service provider A are available for association with the merchant, and payment service provider A is able to determine at least a portion of the sales for the merchant. Payment service provider A analyzes merchant A's history of sales and transactions processed through the payment service provider A and determines that merchant A is a merchant qualified for a business loan at the payment service provider A. Payment service provider A then transmits the qualification information to merchant A; this introduces to merchant A, loan products of the payment service provider A. This message may include an email with an introduction to loan product, for example. In some embodiments, the qualification information is transmitted from server 170 to merchant server 140. Merchant A elects to pursue a loan from payment service provider A

Merchant A responds to the qualification information and initiates an application process between server 140 and server 170. Merchant A may log into her merchant account at payment service provider A. Payment service provider A accesses the account information of merchant A stored in server 170 and as provided from server 140. Based on the sales history and payment transactions of merchant A, payment service provider A determines that merchant A satisfies criteria to enable funding, such as where information indicates that merchant A has good customer rating and steady cash flow. In particular, payment service provider A computer-analysis determines that merchant A consistently has average annual sales revenue above a threshold. Thus, payment service provider A determines that merchant A is qualified for a business loan of an amount up to a maximum amount. Merchant A accepts the maximum loan amount from the payment service provider A.

Payment service provider A may provide several loan options for the loan amount as determined by the computer-analysis of merchant A. The options may include different repayment arrangements such as deducting 10%, 15%, 20%, or 25% of sales revenue as repayment. Each of these repayment arrangements may have a different one-time loan fee. For example, the 10% repayment arrangement has a $900 one-time loan fee, the 15% repayment arrangement has a $800 one-time loan fee, the 20% repayment arrangement has a $700 one-time loan fee, and the 25% repayment arrangement has a $600 one-time loan fee. These repayment options are presented to merchant A for her selection. Payment service provider A also determines the projected pay-off date for each of these options. For example, based on merchant A's current sales revenue, a projected pay-off date for the 10% repayment arrangement.

Merchant A selects the 10% repayment arrangement. The payment service provider transmits the final cost for the loan to server 140. In some embodiments, a borrower's agreement is generated based on merchant A's selection. Merchant A agrees to the borrowing agreement. Payment service provider A may then proceed to issue the loan to merchant A's merchant account. Thus, merchant A receives the business loan and is able to begin the store expansion project.

After the funds are issued to merchant A, server 170 monitors sales transactions of merchant A's merchant account. 10% of daily sales payment is calculated and deducted from merchant A's merchant account for repayment to the loan. During the store expansion project, the sales revenue decreased due to construction at the store. Nevertheless, merchant A does not have to worry about making repayments, because the repayment amount is based on the amount of sales. When merchant A receives less sales, the repayment amount also is less. Even if merchant A does not make any sales on some days, no repayments are required for those days. After the store expansion project is completed, Merchant A sees a tremendous increase in sales and the loan is quickly paid off due to the increase in sales revenue. Merchant A is very pleased with the payment service provider A's loan program and is planning her next business project.

Payment service provider may offer loans to merchants that currently do not have merchant accounts with the payment service provider and/or have relatively recent accounts with the payment service provider. In such server 170 may not have any history of transactions processed for the merchant through the payment service provider, or may have insufficient history of transactions processed for the merchant through the payment service provider. In an embodiment, server 170 may determine an interest rate, such as an annual percentage rate (APR), for a loan to be provided to the merchant so as to mitigate risk of providing a loan to the merchant. The server 170 may determine interest rate for the loan based on merchant data or information that may be available to the payment service provider or that may be relatively quickly obtained by the payment service provider. Generally speaking, the server 170 may process the merchant data or information indicative of risk level of proving a loan to the merchant to assess a risk level of providing a loan to the merchant, and may determine the interest rate in accordance with the risk level of the merchant. For example, the server 170 may determine a relatively higher interest rate for a loan to be provided to a merchant that is assessed to be a relatively higher risk level merchant, such as a merchant of a relatively small size or a merchant with a relatively low sales volume or revenue. On the other hand, the server 170 may determine a relatively lower interest rate for a loan to be provided to a merchant that is assessed to be a relatively lower risk level merchant, such as a merchant of a relatively larger size or a merchant with a relatively higher sales volume or revenue.

In an embodiment, the server 170 may determine a minimum monthly payment for the loan. After issuing the loan to the merchant, the server 170 may begin collecting repayments for the loan from the merchant. For example, the server 170 may cause a percentage of sales of the merchant to be automatically deducted (e.g., form payments collected by the payment service provider for the merchant) and/or may receive and process ad hoc payments made by the merchant. The server 170 may keep track of the repayment amount collected from the merchant in a given month. The server 170 may be configured to suspend collection of repayments once the repayment amount has reached the minimum monthly payment in a given month. Alternatively, the server 170 may be configured to continue collecting repayments after the minimum monthly payment has been reached in a given month. Additional repayments in excess of the minimum monthly payment may allow the merchant to more quickly repay the loan and to thereby pay less interest on the loan.

On the other hand, if the minimum payment is not collected in a given month, the server 170 may increase the interest rate initially determined for the loan. The server 170 may apply the increased interest rate to the unpaid balance for the month, while the remainder of the loan may accrue interest at the initially determined interest rate for the loan. Alternatively, the server 170 may apply the increased interest rate to minimum payments for several following months, or may apply the increased interest rate for the remainder of the loan, or until another monthly minimum is missed by the merchant, in various embodiments.

Generally, the process of determining loan terms that include an interest rate is similar to the process of determining fixed fee loan terms as described above with respect to FIG. 2. Similarly, the process of repayment of an interest rate loan is similar to the process of repayment of a fixed fee loan as described above with respect to FIG. 3. In some embodiments, where applicable, user interfaces the same as or similar to the user interfaces described herein are used to interface with a customer for offering an interest rate loan to the customer and for repayment of the interest rate loan by the customer.

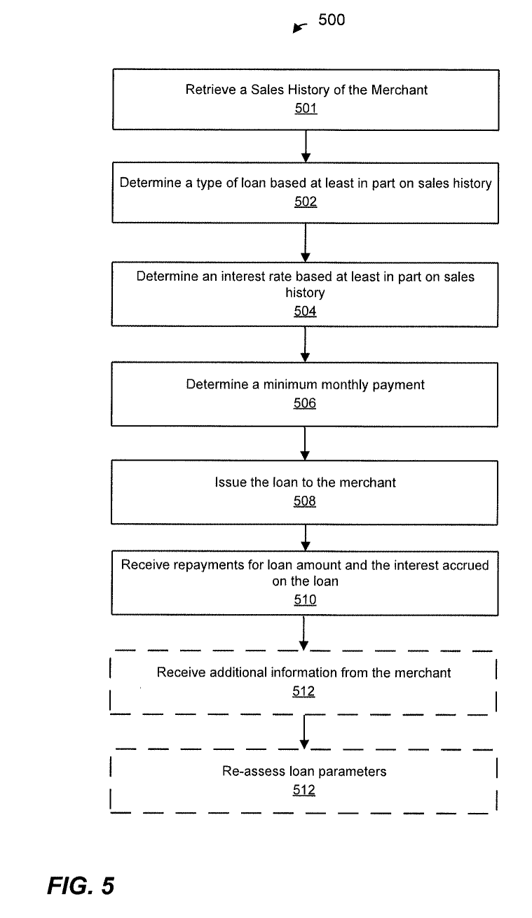

FIG. 5 is a flow chart that illustrates a process 500 for computer-generation of a funding transaction, such as a business loan, according to an embodiment. Process 500 may be executed by a payment service provider server to determine loan terms for a merchant and to issue a loan to the merchant. Process 500 may be executed by a computer or a server of a payment service provider. In an embodiment, process 500 is executed by the payment service provider server 170 of FIG. 1. For example, process 500 is executed by one or more hardware processors of the payment service provider server 170.

At step 501, the payment service provider server 170 retrieves sales history information that may be used by the payment service provider server 170 to assess risk level of providing a loan to the merchant through computer-analysis. The information retrieved at step 501 may include information indicative of and related to the sales history of the merchant. The information indicative of sales history of the merchant may include history of transactions processed for the merchant by the payment service provider and/or history of transactions processed for the merchant by an entity or entities other than the payment service provider. The history of transactions processed for the merchant by the payment service provider may be stored in a non-transitory storage medium at the payment service provider server 170, and may be retrieved at step 501 by the processor of the payment service provider server 170 from the non-transitory storage medium. The history of transactions processed for the merchant by entity or entities other than the payment service provider may be electronically transmitted from the merchant (e.g., from the merchant server 140) to the payment service provider server 170. The information may include a record of sales or revenue of the merchant in a given period of time (e.g., ½ a year, 1 year, 2 years, etc.), a record of credit card payments processed for the merchant in a given period of time, and/or any other suitable financial record of sales, revenue or cash flow of the merchant. As just several examples, the financial record may include information exported from accounting software (e.g., QuickBooks™ software), credit card processing statements, banking statements, etc. The merchant may send the information in an email to the payment service provider, may upload the information to the server 170 of the payment service provider (e.g., via a webpage), or may utilize another suitable method of electronically transmitting the information to the payment service provider server 170.

In addition to the information indicative of the sales history of the payment service provider, the information obtained at step 501 may include other factors such as a net promoter score (NPS) of the merchant, a customer rating of the merchant, a credit score obtained for the merchant, etc. As another example, the information may include information related to the business of the merchant, such as a picture of the business, a picture of inventory, a scan of inventory and the like. In some embodiments, the system 100, as in FIG. 1, a protocol defines the various fields and format for information communications between server 170 and server 140. In this way, information transmitted from server 170 to server 140 is stored and used as indicated by the established or agreed upon protocol. The information stored in server 140 may provide instructions to be used in processing payments and other transactions, such as to initiate a percentage loan repayment to server 170 on each executed transaction. Similarly, information transmitted from server 140 to server 170 identifies and initiates payments and provides transactional information. Server 170 updates the account information as percentage loan repayments are received.

At step 502, the payment service provider server 170 may determine a type or types of loan that may be offered to the merchant. In an embodiment, the payment service provider server 170 determines whether a revolving credit loan and/or a fix loan can be provided to the merchant. The payment service provider server 170 may also determine whether sales-based repayment is to be offered to and/or required from the merchant. The payment service provider server 170 may make these determinations based on the sales history information retrieved at block 501 and/or based on other information that may be available for the merchant. These determinations are made using computer-analysis, and may incorporate machine learning techniques that may enhance processing and reduce risk of providing the loan to the merchant.

At step 504, the payment service provider server 170 may process the information obtained at step 501 to determine an interest rate for a loan to be offered to the merchant. The interest rate may be determined based on the sales history of the merchant and/or based on other information, obtained at step 501, indicative of risk level of the merchant. These determinations are made using computer-analysis, and may incorporate machine learning techniques. The payment service provider server 170 may utilize the information obtained at step 501 to access a risk level of a merchant, and may determine the interest rate for the loan in accordance with the risk level of the merchant. The payment service provider may asses the risk level of the merchant based on sales history or the merchant, size of the merchant, inventory of the merchant, credit score of the merchant, and/or other information that may be obtained for the merchant at step 501. The payment service provider server 170 may offer a relatively higher interest rate to a merchant that is assessed to be a relatively higher risk level merchant, such as a merchant of a relatively small size (e.g., determined based on inventory of the merchant) or a merchant with a relatively low sales volume or revenue. On the other hand, the payment service provider server 170 may offer a relatively lower interest rate to a merchant that is assessed to be a relatively lower risk level merchant, such as a merchant of a relatively larger size (e.g., determined based on inventory of the merchant) or a merchant with a relatively higher sales volume or revenue.

At step 506, the payment service provider server 170 may determine a minimum monthly payment for the loan. The minimum monthly payment may be determined based on expected monthly payment that may be obtained from the merchant as a percentage of estimated or projected monthly sales of the merchant. As an example, the payment service provider server 170 may estimate or project monthly sales of the merchant based on the sales history obtained for the merchant at step 501 and/or based on other information obtained for the merchant at step 501. The payment service provider server 170 may set, or agree-upon, a percentage of sales to be diverted from sales of the merchant as repayments of the loan provided to the merchant. The payment service provider server 170 may determine the minimum monthly payment based on the expected repayment amount that may be collected as the percentage of the sales of the merchant, determined based on the estimated or projected sales of the merchant. For example, the payment service provider server 170 may set the minimum payment to be equal to one half (i.e., 50%) of the expected repayment amount that may be collected as the percentage of the estimated or projected sales of the merchant, in an embodiment. In another embodiment, the minimum monthly payment may be determined in another suitable manner. For example, the payment service provider server 170 may set the minimum monthly payment to be equal to a percentage other than 50% of the expected repayment amount that may be collected as the percentage of the estimated or projected sales of the merchant, or may determine the minimum monthly payment based on a factor or factors other than expected repayment amount that may be collected as the percentage of the estimated or projected sales of the merchant.

At step 508, the payment service provider server 170 may issue the loan to the merchant. The loan may be issued to the merchant as a revolving credit or as a fixed credit loan (e.g., a term loan), for example as determined at step 502. A fixed loan may be issued by the payment service provider server 170 in an amount desired by the merchant, for example up to a qualified maximum loan amount determined based on sales and/or other information available for the merchant. A revolving credit loan may allow the merchant to obtain funds, for example up to a qualified maximum loan amount determined based on sales and/or other information available for the merchant, and to subsequently obtain additional funds when repayment of the initially obtained amount is at least partially collected by the payment service provider server 170. In an embodiment, the payment service provider server 170 may determine a maximum qualified loan amount, and may receive a selection from the merchant indicating a desired loan amount from within the qualified loan amount determined for the merchant. The payment service provider server 170 may determine the maximum qualified loan amount for the merchant based on sales history of the merchant as described above with respect to step 206 of the process 200 of FIG. 2. In another embodiment, the payment service provider server 170 may determine a maximum qualified loan amount in a suitable manner different from the step 206 of the process 200 of FIG. 2. In yet another embodiment, the payment service provider server 170 may not limit the merchant to a maximum qualified loan amount. In this embodiment, the payment service provider server 170 may receive a request for any desired loan amount from the merchant. In some embodiments, the payment service provider server 170 may receive a request for a loan amount from the merchant prior to determining an interest rate for the loan at step 504. In such embodiments, the payment service provider server 170 may utilize the requested loan amount as a factor in assessing the risk level and determining the interest rate for the loan at step 504. Before issuing the loan to the merchant, the payment service provider server 170 may cause the loan terms (e.g., the loan amount, the interest rate, the minimum monthly payments, percentage of sales for repayment, etc.) to be presented to the merchant.

If the loan terms are accepted by the merchant, the payment service provider server 170 may make funds in the loan amount available to the merchant. Optionally, funds may be made available to the merchant as a source for payments to be used for purchases made by the merchant through the payment service provider server 170. For example, the merchant may use the funds to purchase inventory through the payment service provider server 170. The payment service provider server 170 may further facilitate purchase of inventory by the merchant, for example by seeking out lower priced inventory items for the merchant and/or by offering discounts on inventory items purchased through the payment service provider. The payment service provider server 170 may utilize inventory information obtained from the merchant at step 501 to identify the inventory items that may be of interest to the merchant.

Additionally or alternatively, the payment service provider server 170 may make the funds available to the merchant by providing a card, such as a debit card, to the merchant. The card may allow the merchant to make purchases through the payment service provider or through entities other than the payment service provider. For example, the card may allow the merchant to make purchases through any entity that may accept debit cards and/or credit cards as a source of payment. As another option, the payment service provider server 170 may make the funds available to the merchant by transferring the funds in a requested amount (e.g., amount from within a credit line offered to the merchant or amount of a term loan offered to the merchant) to the account of the merchant with the payment service provider.

At step 510, the payment service provider server 170 may collect repayments for the loan from the merchant. The payment service provider server 170 may collect sales-based repayments by monitoring sales of the merchant processed for the merchant by the payment service provider, and diverting the set or agreed-upon percentage of sales as repayments for the loan. For example, the payment service provider server 170 may determine loan repayments based on sales activity as described above with respect to the step 306 of the process 300 of FIG. 3, and may process the repayments by deducting the repayment amount from the merchant's account with the payment service provider as described above with respect to the step 310 of the process 300 of FIG. 3. In an embodiment, payment service provider server 170 may process repayments periodically, for example daily. For example, the payment service provider server 170 may deduct the set percentage from a batch of daily transactions processed by the payment service provider. The payment service provider server 170 may deduct the set percentage of sales may be collected upon processing the batch of daily transactions. In another embodiment, the payment service provider server 170 may process repayments in “real time,” for example by deducting a repayment from each individual transaction processed for the merchant by the payment service provider. The payment service provider server 170 may deduct the set percentage of each individual transaction upon processing the transaction. In addition to, or instead of, providing repayments of the loan as a portion of sales, merchants may optionally provide direct repayments for the loan, for example as described herein.

In an embodiment, the method 500 optionally includes steps 512 and 514. At step 512, the payment service provider server 170 may receive additional and/or updated information from the merchant server 140 and/or the merchant device 157. For example, the merchant server 140 and/or the merchant device 157 may transmit to the payment service provider server 170 information related to merchant's inventory, information related to sales transactions, including, for example, time of the sales transactions, processed by the merchant device 157 and/or the merchant server 140, customer information maintained by the mobile device 157 and/or the server 140, and so forth.

At step 514, the payment service provider server 170 may use information received at step 512 to reassess loan terms for the merchant. For example, the payment service provider server 170 may use information received at step 512 to re-assess the risk level associated with the merchant and to readjust loan parameters, such as rolling credit amount, interest rate, percentage of sales diverted for repayment and so forth, of the loan provided to the merchant. As just an example, in an embodiment, the payment service provider server 170 utilizes information received at step 512 to adjust repayment percentage of sales to be collected for repayment of the loan from the merchant, thereby implementing a variable repayment- percentage loan for the merchant. In an embodiment, steps 512 and 514 are performed multiple times during the process or repayment of the loan by the merchant. For example, in an embodiment, steps 512 and 514 are performed periodically (e.g., daily, bi-monthly, monthly, etc.) or on ad-hoc basis. The risk re-assessment at block 514 is performed using computer-analysis, and may incorporate machine learning techniques that may enhance processing and reduce risk of providing the loan to the merchant.

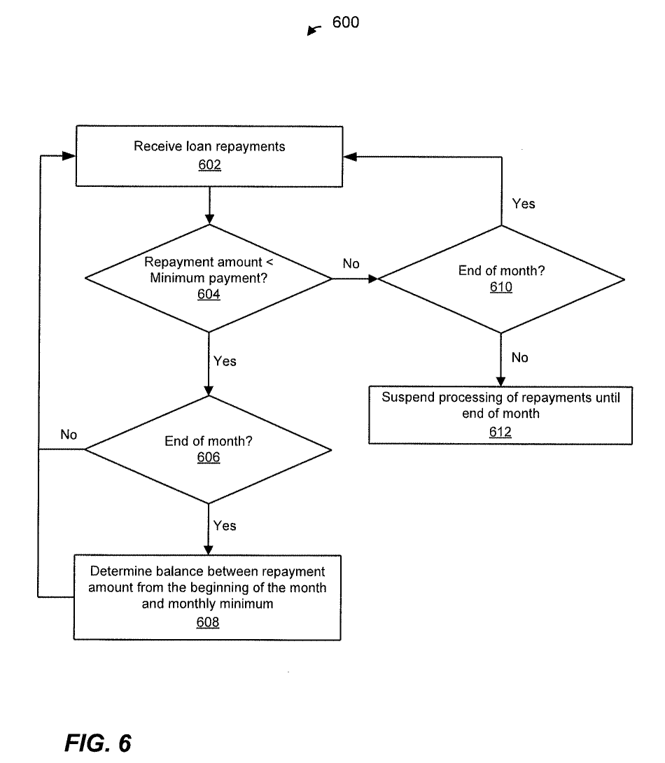

FIG. 6 is a flowchart illustrating a repayment process 600, according to an embodiment. Process 600 may be executed by a payment service provider server to collect repayment of a loan issued to a merchant. Process 600 may be executed by a computer or a server of a payment service provider. In an embodiment, process 600 may be executed by the payment service provider server 170 of FIG. 1. For example, process 600 may be executed by one or more hardware processors of the payment service provider server 170. Process 600 may be implemented at step 510 of the process 500 of FIG. 5, in an embodiment.

At step 602, one or more repayments may be received at the payment service provider server 170 from the merchant. At step 602, repayment amount received from the merchant from a beginning of a month may be compared to a minimum monthly payment, such as the minimum monthly payment determined at step 506 of the process 500 of FIG. 5. Based on the comparison, it is determined at step 604 whether the repayment amount received from the merchant from the beginning of the month is less than or is greater or equal to the minimum monthly payment. If it is determined at block 604 that the repayment amount received from the merchant from the beginning of the month is less than the minimum monthly payment, then the process 600 continues at step 606 at which it is determined whether the end of the month has been reached. If it is determined at step 606 that the end of month has not yet been reached, the process 600 returns to the step 602 at which the payment service provider server 170 may continue receiving repayments for the loan.

On the other hand, if it is determined at step 606 that the end of month has been reached, this signifies that the merchant has not met the minimum monthly repayment for the month. In this case, at step 608, a difference between the repayment amount received from the beginning of the month and the minimum monthly repayment may be determined. The payment service provider server 170 may apply an increased interest rate on the difference between the repayment amount received from the beginning of the month and the minimum monthly repayment until the difference is repaid by the merchant, in an embodiment. The remainder of the loan may continue to accrue interest at the initially determined interest rate for the loan. The payment service provider server 170 may be configured to apply future repayments received for the loan to the difference until the difference is repaid and to then start applying repayments to the remainder of the loan so as to minimize effect of the increased interest rate for the merchant.

Returning to step 604, if it is determined that the repayment amount received from the merchant from the beginning of the month is greater than or equal to the minimum monthly payment, then the process 600 continues at step 610. At step 610 it is determined whether the end of the month has been reached. If it is determined at step 610 that the end of month has been reached, the process 600 returns to the step 602 at which the payment service provider server 170 begins to receiver repayments for the following month. On the other hand, if it is determined at step 610 that the end of month has been reached, this signifies that the merchant has met the minimum monthly repayment for the month before the end of the month. In this case, at step 612, the payment service provider server 170 may suspend collecting repayments until the end of the month. Alternatively, the payment service provider server 170 may continue collecting payments after the merchant has met the minimum payment for the month. Continuing collection of payments after the merchant has met the minimum payment for the month may allow the merchant to repay the loan more quickly to thereby pay less total interest on the loan.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context herein (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A method of providing working capital to a merchant, the method executed by one or more hardware computer processors programmed to perform the method, the method comprising:
obtaining, at one or more hardware processors of a payment service provider, information indicative of a sales history of the merchant;
determining, at the one or more hardware processors of the payment service provider based on the information indicative of the sales history of the merchant, an interest rate for a loan to be offered to the merchant;
receiving, at the one or more hardware processors of the payment service provider from the merchant, a loan amount for the loan;
issuing, by the one or more hardware processors of the payment service provider, the loan, in the loan amount, to the merchant; and
collecting, from the merchant, repayments for the (i) loan and (ii) interest accrued on the loan according to the interest rate determined for the loan.

2. The method of claim 1, wherein the information indicative of the sales history of the merchant includes history of transactions processed for the merchant by the payment service provider, and wherein obtaining the sales history at the one or more hardware processors of the payment service provider includes retrieving, by the one or more hardware processors of the payment service provider, the history of transactions from a non-transitory storage medium at the payment service provider.

3. The method of claim 1, wherein the information indicative of the sales history of the merchant includes history of transactions processed for the merchant by an entity other than the payment service provider, and wherein obtaining the sales history comprises receiving, from the merchant via a network, the information at the one or more hardware processors of the payment service provider.

4. The method of claim 3, further comprising
setting, at the one or more hardware processors of the payment service provider, a percentage of sales to be diverted from the merchant as repayment of the loan;
monitoring, at the one or more hardware processors of the payment service provider, transactions of the merchant processed by the payment service provider; and
collecting, at the one or more hardware processors of the payment service provider, the set percentage of sales from the transactions of the merchant as repayments for the loan.

5. The method of claim 4, wherein collecting the set percentage of sales comprises collecting the set percentage of each individual transaction processed for the merchant by the payment service provider, wherein the set percentage of each individual transaction is collected upon processing the transaction.

6. The method of claim 4, wherein collecting the set percentage of sales comprises collecting the set percentage of a batch of daily transactions processed by the payment service provider, wherein the set percentage of sales is collected upon processing the batch of daily transactions.

7. The method of claim 1, further comprising determining, at the one or more hardware processors of the payment service provider, a minimum monthly repayment for the loan.

8. The method of claim 7, further comprising
determining, at the one or more hardware processors of the payment service provider, a repayment amount collected for the loan from a beginning of a month;
comparing, at the one or more processors of the payment service provider, the repayment amount collected for the loan from the beginning of the month to the set monthly minimum repayment amount;
determining, based on the comparison, that the monthly minimum payment amount has been met for the month before an end of the month; and
in response to determining that the monthly minimum payment amount has been met for the month before the end of the month, suspending collection of repayments until the end of the month.

9. The method of claim 7, further comprising
comparing, at the one or more hardware processors of the payment service provider, an amount of repayments collected in a month to the monthly minimum repayment amount;
determining, at the one or more hardware processors of the payment service provider based on the comparison, whether the repayment amount collected in the month is below the minimum monthly repayment amount; and
when it is determined that the repayment amount collected in the month is below the minimum,
determining, at the one or more hardware processors of the payment service provider, a difference between the minimum repayment amount and the repayment amount collected in the month, and
applying, at the one or more hardware processors of the payment service provider, an increased interest rate to the difference between the minimum repayment amount and the repayment amount collected in the month.

10. The method of claim 1, further comprising determining, at the one or more hardware processors of the payment service provider based on the sales history of the merchant, a maximum qualified loan amount for the merchant, wherein receiving the loan amount from the merchant comprises receiving the loan amount within the qualified loan amount.

11. A tangible, non-transitory computer readable medium, or media, storing machine readable instructions that, when executed by one or more processors of a payment service provider, cause the one or more processors to:
obtain information indicative of a sales history of a merchant;
determine, based on the information indicative of the sales history of the merchant, an interest rate for a loan to be offered to the merchant;
receive, from the merchant, a loan amount for the loan;
issue the loan, in the loan amount, to the merchant; and
collect, from the merchant, repayments for the (i) loan and (ii) interest accrued on the loan according to the interest rate determined for the loan.

12. The non-transitory computer-readable medium or media of claim 11, wherein
the information indicative of the sales history of the merchant includes history of transactions processed for the merchant by the payment service provider, and
the computer readable medium or media store machine readable instructions that, when executed by one or more processors, cause the one or more processors to retrieve the history of transactions from a non-transitory storage medium at the payment service provider.

13. The non-transitory computer-readable medium or media of claim 11, wherein
the information indicative of the sales history of the merchant includes history of transactions processed for the merchant by an entity other than the payment service provider, and
computer readable medium or media store machine readable instructions that, when executed by one or more processors, cause the one or more processors to receive the information from the merchant via a network.

14. The non-transitory computer-readable medium or media of claim 13, further storing machine readable instructions that, when executed by one or more processors, cause the one or more processors to
set a percentage of sales to be diverted from the merchant as repayment of the loan;
monitor transactions of the merchant processed by the payment service provider; and
collect the set percentage of sales from the transactions of the merchant as repayments for the loan.

15. The non-transitory computer-readable medium or media of claim 14, wherein collecting the set percentage of sales comprises collecting the set percentage of each individual transaction processed by the payment service provider, wherein the set percentage of each individual transaction is collected upon processing the transaction.

16. The non-transitory computer-readable medium or media of claim 14, wherein collecting the set percentage of sales comprises collecting the set percentage of a batch of daily transactions processed by the payment service provider, wherein the set percentage of sales is collected upon processing the batch of daily transactions.

17. The computer readable medium or media of claim 11, further storing machine readable instructions that, when executed by one or more processors, cause the one or more processors to determine a minimum monthly repayment for the loan.

18. The non-transitory computer-readable medium or media of claim 17, further storing machine readable instructions that, when executed by one or more processors, cause the one or more processors to
determine a repayment amount collected for the loan from a beginning of a month;
compare the repayment amount collected for the loan from the beginning of the month to the set monthly minimum repayment amount;
determine, based on the comparison, that the monthly minimum payment amount has been met for the month before an end of the month; and
in response to determining that the monthly minimum payment amount has been met for the month before the end of the month, suspend collection of repayments until the end of the month.

19. The non-transitory computer-readable medium or media of claim 17, further storing machine readable instructions that, when executed by one or more processors, cause the one or more processors to
compare an amount of repayments collected in a month to the monthly minimum repayment amount;
determine, based on the comparison, whether the repayment amount collected in the month is below the minimum monthly repayment amount; and
when it is determined that the repayment amount collected in the month is below the minimum,
determine a difference between the minimum repayment amount and the repayment amount collected in the month, and
apply an increased interest rate to the difference between the minimum repayment amount and the repayment amount collected in the month.

20. The non-transitory computer-readable medium or media of claim 11, further storing machine readable instructions that, when executed by one or more processors, cause the one or more processors to
determine, based on the sales history of the merchant, a maximum qualified loan amount for the merchant,
receive the loan amount from the merchant from within the qualified loan amount.
